(19) United States
(12) Patent Application Publication
(10) Pub. No.: US 2013/0151428 A1
(43) Pub. Date: Jun. 13, 2013

(54) REAL-TIME INSPECTION OF COMMODITIES IN AN INTEGRATED INFORMATION MANAGEMENT SYSTEM

(71) Applicants: GUNTHER HESSE, Walldorf (DE); Michael Krenkler, Wiesloch (DE)

(72) Inventors: GUNTHER HESSE, Walldorf (DE); Michael Krenkler, Wiesloch (DE)

(21) Appl. No.: 13/313,027

(22) Filed: Dec. 7, 2011

(51) Int. Cl. G06Q 10/00

(52) U.S. Cl. 705/318

(57) ABSTRACT

Various embodiments of systems and methods for inspecting commodities and providing an evaluation proposal in real-time in an integrated information management system are disclosed herein. The method includes configuring (110) one or more events recorded in the inspection system as an inspection trigger. The inspection trigger is set-off (120) in response to recording at least one event of the one or more events. Further the method includes generating (130) an inspection template, by a processor of the computer, in response to the inspection trigger. The inspection template is then rendered (140) on an inspection device within the information management system. Further, the method includes extracting (150) inspection data from the inspection template and providing an evaluation proposal based on analyzing (160) the inspection data.

### FIELD

The field relates generally to integrated information management systems. More specifically, the field relates to inspecting commodities and providing an evaluation proposal in real-time in an integrated information management system.

### BACKGROUND

Product inspection and reporting processes have gained significance as manufacturers and sourcing partners show increased interest towards insuring high quality products and services. Also, such inspection processes can help insure that the products are safe and in compliance with current laws and standards and avoid resulting financial liabilities. Product inspection includes Pre-product inspection, Receiving inspection, Final inspection, In-process control, and recurring inspection. Product inspection includes inspecting the raw materials and components that go into making the product. It is important to obtain timely and accurate reports so that timely decisions can be made and limit down time.

However, traditional inspection processes and subsequent reporting processes involved in the manufacturing/sourcing industries have been inconsistent, slow, manually labor intensive, and prone to human errors. For example, an inspector on the field would examine an asset and record his or her findings, at best, in an electronic form. The inspector may record his findings using text, images, digital photographs, video, barcodes, digital sketches, audio, graphics, etc. A data processing personnel/system then subsequently processes this information to assemble an electronic collection of data that must undergo labor-intensive conversion process into a format that can interface with multiple business channels and diverse requirements. Such data conversion processes result in redundant data processing efforts. Also, the collected inspection data tends to be incomplete and inaccurate due to varying inspection practices followed by different inspection personnel and for different products. Moreover, the data processing personnel/system may have to communicate back and forth with the inspector to decipher the information. Another challenge that accompanies the traditional inspection processes is the lack of a system to provide up-to-date information regarding the current laws and standards pertaining to inspection processes and products.

### SUMMARY

Various embodiments of systems and methods for inspecting commodities, and providing an evaluation proposal in real-time in an integrated information management system are described herein. A method for providing an evaluation proposal in an integrated information management system involves configuring one or more events recorded in the inspection system as an inspection trigger. For instance, an event such as the recording of the arrival of commodities at a procurement site can be configured as an inspection trigger. The inspection trigger is set-off in response to recording at least one event of the one or more events. In a further aspect, the method includes generating an inspection template by a processor of the computer, in response to the inspection trigger. The inspection template is then rendered on an inspection device within the information management system. In yet another aspect, the method involves, extracting inspection data from the inspection template and providing an evaluation proposal based on analyzing the inspection data. The inspection data is collected by inspecting one or more commodities.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram of a method for inspecting commodities, and providing an evaluation proposal, according to one embodiment.

FIG. 2 forms a signal flow diagram illustrating the sequence of operation within the integrated information management system, according to one embodiment.

FIG. 3 is a block diagram of an exemplary system for inspecting commodities and providing an evaluation proposal, according to one embodiment.

FIG. 4 illustrates an exemplary user interface of an inspection device displaying an inspection template, in accordance with an embodiment.

FIG. 5 illustrates a dashboard for providing inspection data rendered on a graphical user interface, in accordance with an embodiment.

FIG. 6 illustrates a block diagram of an exemplary computer system configured in accordance with an embodiment.

### DETAILED DESCRIPTION

Embodiments of techniques for inspecting commodities and providing an evaluation proposal in real-time in an integrated information management system are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

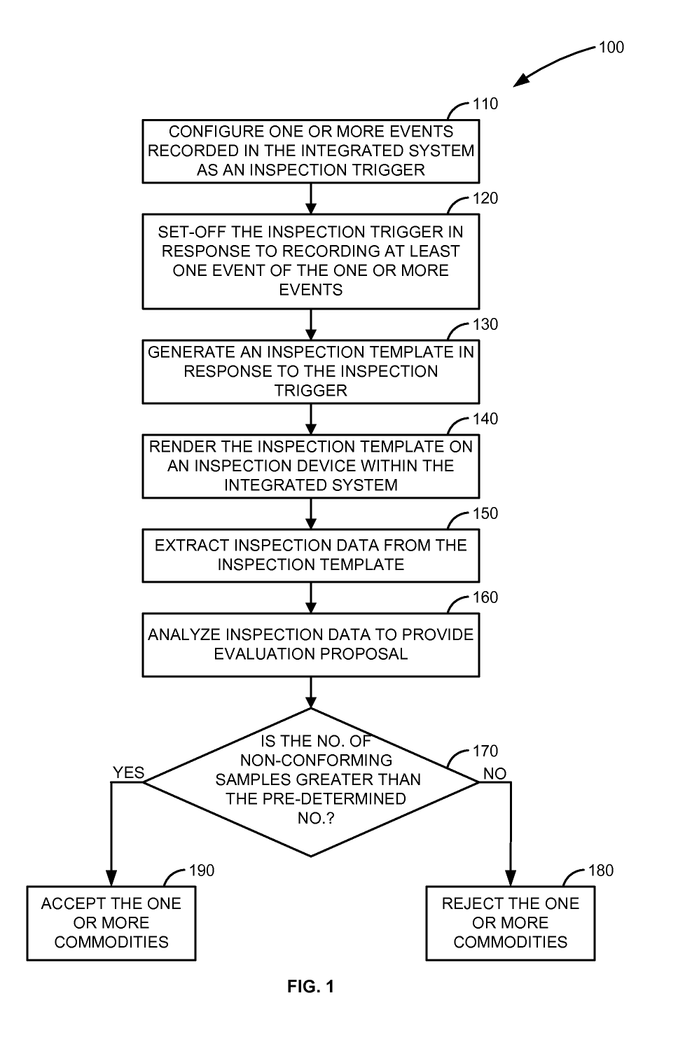

FIG. 1 illustrates a flow diagram of a method 100 for inspecting one or more commodities and providing an evaluation proposal in real-time, according to an embodiment. The method 100, implemented by a computer in an integrated information management system, includes configuring (110) one or more events recorded in the system as an inspection trigger. The one or more events refer to an event that is recorded within an integrated information management system. Examples of the one or more events recorded in the system include Pre-product inspection, Receiving inspection during supplier delivery/customer return/stock transfer, Final inspection during production/customer shipment/stock transfer, In-process control, recurring inspection during shelf-life test/calibration/stability study, receiving commodities from a supplier, a planned time of inspection, a fault in production line, periodic defect analysis, periodic vendor evaluation, and measures resulting from a strategic decision. In an embodiment, the integrated information management system is an on-demand integrated business management solution in which software and associated data are hosted centrally, e.g., on the internet and accessed by a computer using a web browser. In another embodiment, the integrated information management system is an Enterprise Resource Planning (ERP) system having a plurality of business modules which are integrated to each other over a communication network. Further, the ERP system is enabled with automated pull mechanisms allowing real-time processing and execution of inspection data. As used herein the term “real-time” refers to a time frame that is brief, appearing to be immediate or near concurrent. When the computer processes data in real time, it reads and handles data as it is received, producing results without delay. Referring back to FIG. 1, when at least one event that has been configured as an inspection trigger is recorded in the system, the inspection trigger is automatically set-off (120) unless an override feature is enabled. The inspection trigger then automatically generates (130) an inspection template to be rendered on a user interface based on a predefined inspection plan. The predefined inspection plan includes specification relating to sampling procedures and inspection instructions which can be set-up in the inspection system. Examples of sampling procedures include I.D.s of parts, samples, batches, lots or serialized products to be inspected, order of performing inspection, and acceptance no. The inspection instructions may include predefined instructions for providing an evaluation proposal such as providing a recommendation to accept or reject stock, providing a quality decision, providing usage decision, and creating/updating/maintaining a supplier track record, etc. The inspection template is configured to aid an inspection personnel or an automaton in recording inspection data collected by inspecting one or more commodities.

In an embodiment, the inspection template is customized in order to facilitate optimal inspection of commodities. For example, the inspection template is customized according to a product or business partner (supplier/customer) of interest and includes additional information such as I.D.s of parts, samples, batches, lots or serialized products to be inspected, order of performing inspection, and number of samples to be inspected, specific to the product or business partner of interest. In an example, the product of interest may be a commodity that goes into manufacturing an end product or a product by itself, that needs to be inspected for defects. The terms “commodity,” “goods,” and “product” will hereinafter be used interchangeably and refer to one and the same. Examples of commodity include finished products, raw materials, parts, spares, components, and computer readable storage mediums. The term “sample” hereinafter be used might be a subset of a product/material to be inspected, such as batch, lot, serialized product, equipment or physical sample. The business partner of interest is a supplier vending the product of interest, a customer receiving the product, or an entity handling a product in a manufacturing process. The term “defects” as disclosed herein refers to any type of non-conformance with a set of pre-determined requirements or standards. Also, the term “inspection” as used herein, includes but is not limited to examination of the commodity for defects using manual, automated, visual, sonic, RF, IR, mechanical, electrical, or electronic means.

In an embodiment, the generated inspection template is rendered (140) on a user interface of an inspection device within the ERP system. Examples of the inspection device include a portable communication device, laptop, PDA, or a hand-held electronic device capable of communicating over the communication network. Further, the method includes extracting (150) inspection data from the inspection template and providing an evaluation proposal in real-time, based on analyzing (160) the inspection data. In an example embodiment, analyzing the inspection data involves determining (170) whether the number of non-conforming samples or number of defects of the commodities is according to the predefined specification, set up in an inspection plan. The predetermined limit may be an acceptance no. recommended by a current international safety standard or regulation. If the number of non-conforming samples/defects is above a predetermined limit, the system may recommend that the received commodities be rejected (180). If the number of non-conforming samples is equal to or below the predetermined limit, the system may recommend that the received commodities be accepted (190). In another embodiment, analyzing the inspection data involves determining a number of defects or make a quality decision based on the number of defects.

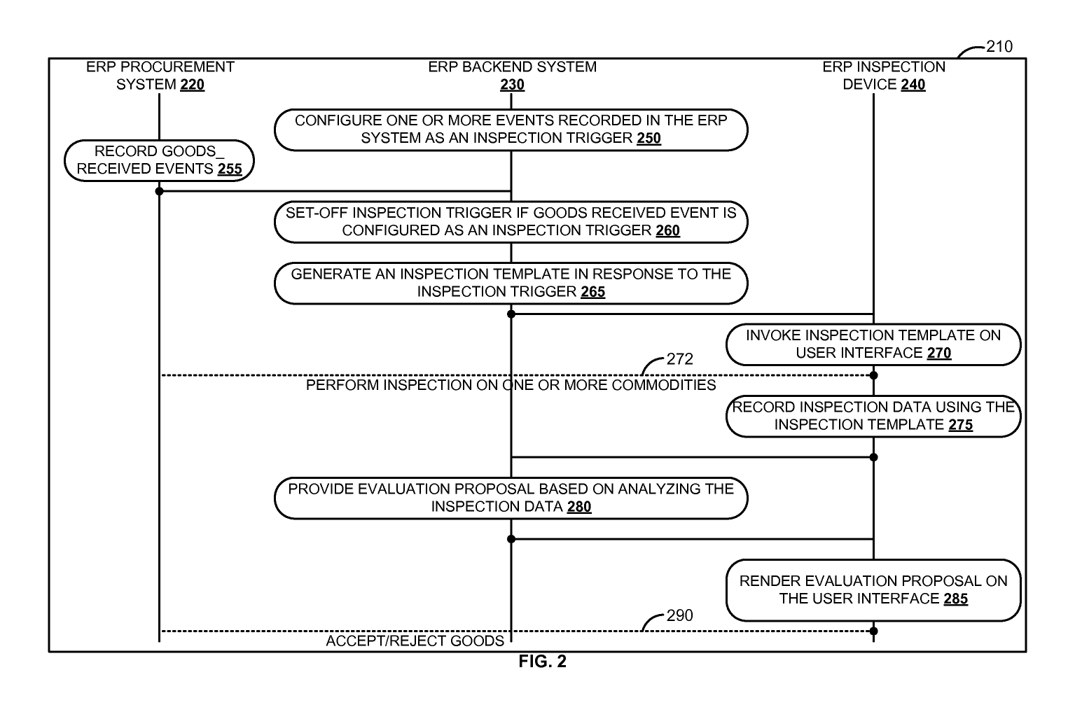

FIG. 2 shows a signal flow diagram illustrating the sequence of operation within the integrated information management system, according to one embodiment. The signal flow diagram illustrates the sequence of operation among integrated subsystems within an integrated information management system 210 such as an ERP system. The ERP system 210 as understood herein is an exemplary integrated system in which a specialized subsystem such as a backend system 230 is dedicated to communicate between other subsystems 220, 240. Further, the integration between the subsystems 220, 230, and 240 avoids the need for interfaces and middleware for interfacing and converting data to/from every other application formats. Further, the integrated system 210 enables automatic pull mechanism and transparency between subsystems 220, 230, and 240 leading to real-time processing of information. In the given example, the sequence of operations between an ERP procurement system 220, ERP backend system 230, and an ERP inspection device 240 is shown. In an embodiment, the operations performed at the inspection device 240 can be performed at any computer within the ERP system 210.

The operations involved in collecting inspection data using an inspection template and providing an evaluation proposal is initiated by configuring (250) one or more events recorded in the ERP system 210 as an inspection trigger. For example, an event recorded in a procurement module of the procurement system 220, relating to the disbursement of goods at a procurement site, may be configured as an inspection trigger. During an actual recording (255) of a goods received event in the ERP procurement system 220, an inspection trigger is set-off (260) at the ERP backend system 230. In response to the inspection trigger, an inspection template is generated (265) by a processor of a computer in the backend system 230. The generated inspection template can be accessed throughout the ERP system 210 and particularly at the Inspection device 240. The inspection template invoked (270) on the user interface of the inspection device 240 is used for recording (275) inspection data collected from inspecting (272) the commodities at the procurement site 220. The processor of the computer in the backend system 230 analyzes (280) the inspection data and forms an evaluation proposal. The evaluation proposal may be automatically rendered (285) on the user interface of the inspection device 240. The evaluation proposal may include a recommendation to reject the commodities, accept the commodities, or re-inspect the commodities for a different set of samples. The commodities may then be accepted or rejected (290) according to the souring recommendation.

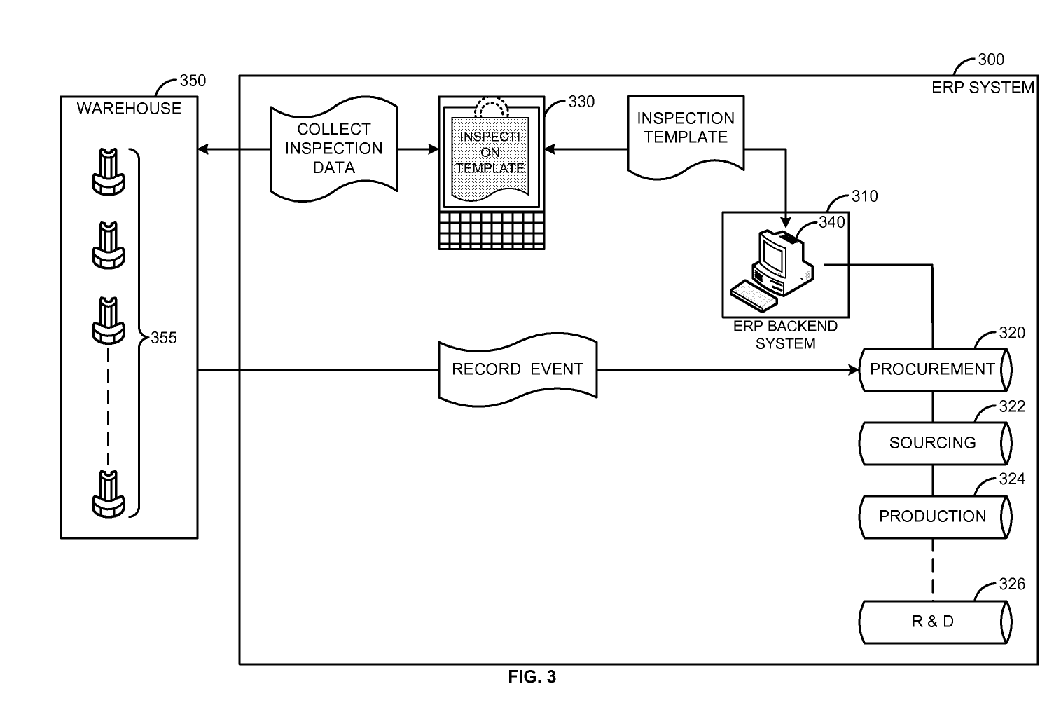

FIG. 3 is a block diagram of an exemplary system 300 for inspecting commodities and providing an evaluation proposal, according to one embodiment. The system 300 includes a backend system 310, one or more business modules 320, 322, 324, and 326, and an optional inspection device 330. In an embodiment, the system 300 is an ERP system integrated over a communication network. The ERP system 300 includes business modules relating to procurement 320, sourcing 322, production 324, and R&D 326. The ERP backend system 310 may include a computer 340 operating in communication with the business modules 320, 322, 324, and 326, and, although not shown in figure, external data source systems, Business Intelligence tools, data repository. Data source systems include sources of data that enable data storage and retrieval. Data source systems may include databases, such as, relational, transactional, hierarchical, multi-dimensional (e.g., OLAP), object oriented databases, and the like. Data source systems may also include a data source where the data is not tangibly stored or otherwise ephemeral such as data streams, broadcast data, and the like. These data source systems can include associated data foundations, semantic layers, management systems, security systems and so on. The BI tools include executable instructions required to turn the data into information such as standard reports, queries, analytical applications, OLAP analysis, exception based reporting, data mining etc.

The computer 340 includes a processor that executes software instructions or code stored on a computer readable storage medium to perform the above-illustrated methods. The computer 340 includes a media reader to read the instructions from the computer readable storage medium (CRSM) and store the instructions in storage or in random access memory (RAM). For example, the CRSM includes executable instructions for performing operations including, but not limited to, configuring trigger events, generating the inspection template, analyzing the inspection data, and providing an evaluation proposal. In an embodiment, the software instructions or code required to perform the above-illustrated methods are accessed as an on-demand software, i.e. Software as a Service (SaaS) over the internet by the computer using a web browser. The business modules relating to procurement, sourcing, production, and R&D, among others, may each include a computer (not shown) operating on a set of instructions to perform associated functions.

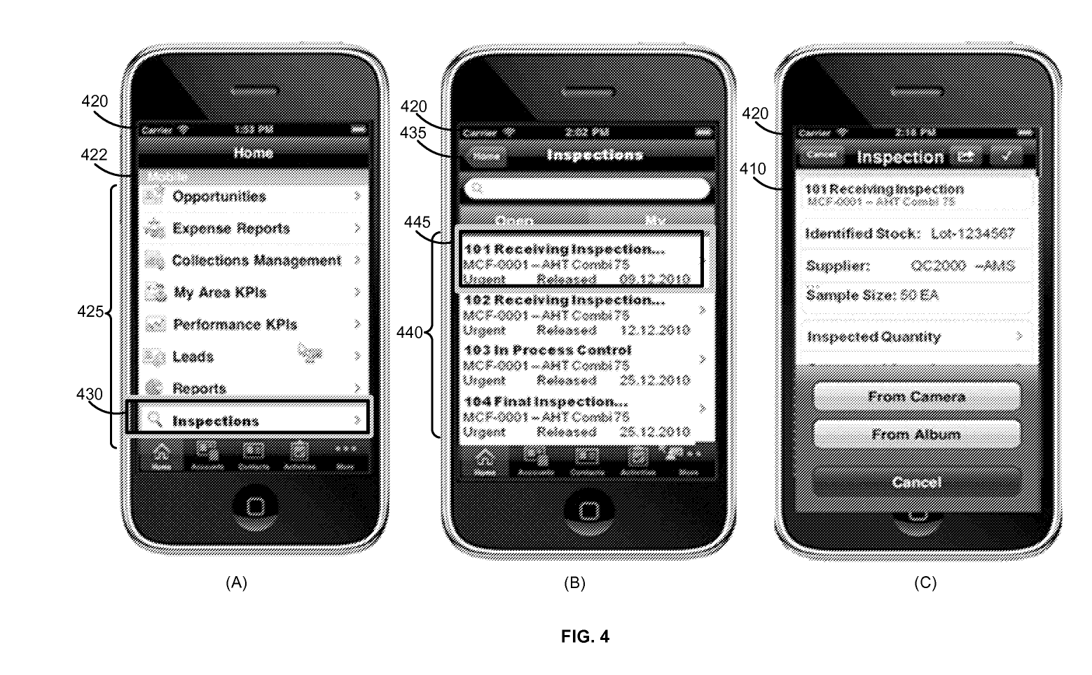

In an embodiment, the inspection device 330 includes a portable communication device, a hand-held electronic device, or a portable computing device. By way of example, the inspection device is a mobile communication device having a user interface and capable of communicating with the backend system 310 over a communication network. The user interface of the inspection device 330 is configured to display an inspection template generated in the backend system 310 as will be discussed in more detail later with reference to FIG. 4.

According to an aspect, the computer's 340 memory holds set of events that are pre-configured as inspection trigger events, such that, the processor upon sensing that one or more events recorded in the backend system 310 matches the pre-defined inspection trigger events in the memory, sets-off an inspection trigger. In an example, the set of events include receiving goods from a supplier, Pre-product inspection, Receiving inspection during supplier delivery/customer return/stock transfer, Final inspection during production/customer shipment/stock transfer, In-process control, recurring inspection during shelf-life test/calibration/stability study, a planned time of inspection, a fault in production line, periodic defect analysis, periodic vendor evaluation, and strategic decision. In response to the inspection trigger, the processor generates an inspection template that is capable of being rendered on a user interface of the computer 340 in the backend system 310 or any other computer on the ERP system 300. The inspection template can also be evoked on the user interface of the inspection device 330 within the ERP system 300. In an embodiment, the processor automatically generates a customized inspection template based on identifying one or more predefined criteria. The term “customized” as used herein refers to adapting the attributes of the inspection template according to the one or more predefined criteria. By way of example, the one or more predefined criteria may include a business partner (supplier/customer) name or ID, product name or ID, product category, batch/lot ID, place of receipt/issue of commodities/products, place of origin of commodities, country of origin of commodities. In an example, the inspection template is customized for a product “XYZ” from a supplier “ABC”. The processor may also take into consideration, the geographic region(s) where the product will be marketed such that the inspection template is adapted in compliance with the governing laws and standards for that region. The criteria for customizing the inspection template may be pre-configured according to business needs, or can be selected in real-time.

In an embodiment, the customized inspection template is auto-populated with certain information collected from the various business modules 320, 322, 324, and 326. For example, the procurement module 320 of the ERP system 300 may provide certain information regarding the supplier or product such as the product's model no., while the sourcing module 322 may provide information identifying the stock no. and the production module 324 may provide information identifying the parts of the product. Since the system 300 is integrated in real-time, any updates made to the business modules 320, 322, 324, and 326 or data source systems get reflected instantly at the backend system 310 so that the generated inspection template is customized based on the latest available data. For example, the data source system may provide information relating to safety laws and standards for a particular territory. Since safety laws and regulations are subject to amendments from time to time, the data source system may provide updated information from time to time. Since the business modules 320, 322, 324, and 326 in the ERP system 300 are integrated in real-time, the inspection template generated at any instant of time remains up-to-date. Further, the inspection template may be auto-populated with information regarding the minimum number of samples that need to be inspected. For example, the minimum no. of samples to be inspected may be based on a governing law or standard, certification criteria, identified stock, product, product category or supplier/customer.

The inspection template generated by the processor can be instantly accessed throughout the system 300. In an embodiment, the inspection template is automatically rendered on the inspection device 330. The inspection template includes customized information and fields for entering inspection data. The inspection data may be collected by manual examination of commodities 355 at a warehouse 350 by an inspection personal, machine vision systems, or an automaton. Again, the inspection data may be manually entered into the inspection template or through automated digital means.

The processor in the backend system 310 or in the inspection device 330 processes the inspection data entered in the inspection template, and provides a dashboard projecting details of the inspection along with an evaluation proposal. For example, the dashboard may display information regarding initiating process, product, business partner, sample size, parts inspected, destructed parts, no. of faulty parts, faulty samples, no. of non-conforming samples in the sample size, evaluation proposal, etc. The dashboard may be instantly rendered on the inspection device 330 so that a sourcing action may be performed based on the evaluation proposal provided on the dashboard. For example, inspection personnel at the warehouse 350 may, consequent to performing the inspection, send the commodities 355 back to the supplier based on a recommendation to reject the inspected stock, provided on the dashboard.

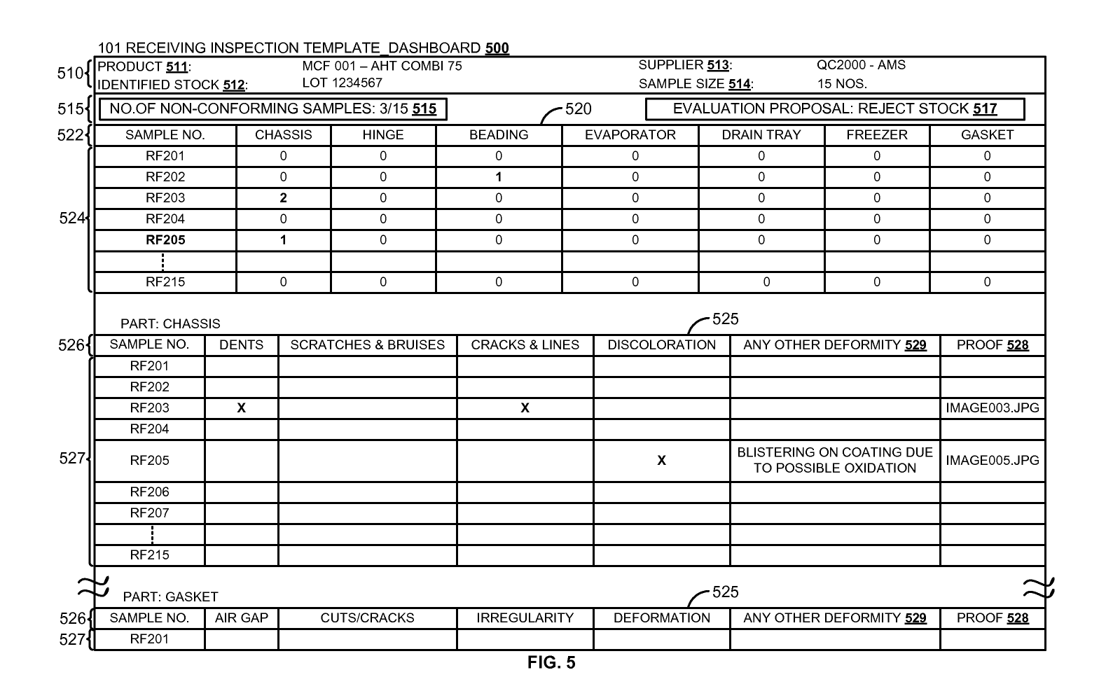

FIG. 4 illustrates an exemplary user interface of an inspection device 330 displaying an inspection template. In the given example, the process of invoking an inspection template 410 on the user interface 420 of the inspection device 330 is illustrated through FIG. 4(a)-(c). FIG. 4(a) illustrates the user interface 420 displaying a “Home” menu 422 having a list of selections 425. The Home menu 422 is the menu that is presented to a user for accessing various applications and databases by navigating through the list of selections 425. In the given example, the Home menu 422 includes selections 425: Opportunities, Expense Reports, Collections management, My Area KPIs, Performance KPIs, Leads, Reports, Inspections, etc. FIG. 4(a) shows that Inspection selection 430 is currently selected in order to access the inspection template 410. Home menu 422 may be navigated through one or more input and control modes including but not limited to a key pad, toggle keys, joystick, touchpad, touch screen, motion sensor, and microphone. Selecting the Inspection selection 430 by means of a select key invokes a sub-menu 435 under Inspections selection 430 as shown in FIG. 4(b). The Inspections sub-menu 435 presents sub-selections 440 for a user to access applications relating to Inspection. In the given example, the Inspections sub-menu 435 includes sub-selections 440: 101 Receiving Inspection, 102 Receiving Inspection, 103 In Process Control, 104 Final Inspection etc., for accessing a corresponding inspection template 410. FIG. 4(b) shows that the sub-selection 101 Receiving Inspection (445) is currently selected for accessing the corresponding inspection template 410. As shown in FIG. 4(c), the inspection template 410 corresponding to 101 Receiving Inspection selection 445 is displayed on the user interface 420. The inspection template 410 will be described in more detail with reference to FIG. 5. Any of the input modes may be used for entering inspection data into the inspection template 410. The inspection template 410 may also provide options for uploading image data from a camera or an image repository.

FIG. 5 illustrates a dashboard 500 for an inspection report rendered on a graphical user interface, in accordance with an embodiment. In the given example, a filled-in inspection template (inspection template) is illustrated as a dashboard 500 presented on a graphical user interface of the computer or the inspection device. The dashboard 500 provides a general overview of the attributes involved in arriving at an evaluation proposal. The dashboard includes an information deck 510, a field providing an evaluation proposal 517, a field providing no. of non-conforming samples data 515, a field providing no. of defects, a Summary Table 520 providing sample details, and Tables 1-n (525) for displaying inspection data, such as defect locations, defect types or measured values. The information deck 510, header fields 522 and 524 in the Summary Table 520, skeletons for Tables 1-n (525), and the header fields 526 and 527 in the Tables 1-n (525) are automatically populated in the inspection template at the time of generation by the processor. Specifically, the values in the information deck 510 and the header fields 522, 524, 526, and 527 for the Tables 520 and 525 are customized according to the commodity being inspected and/or the supplier/customer whose commodity is being inspected.

The evaluation proposal provided under the evaluation proposal field 517 may be represented as a visual indicator, an audio indicator, a numerical indicator, a string of characters, or a combination. In the illustrated embodiment, the evaluation proposal is provided as a word or phrase such as “reject stock,” “accept stock,” “re-sample stock,” “scrap stock,’ or “rework stock.” The field 515 providing data on the no. of non-conforming samples provides a number of non-conforming samples for a given sample size. In the given example, the field 515 provides a numerical value of 3/15 indicating that there are 3 non-conforming samples for a sample size of 15 and field 517 provides an evaluation proposal to reject the inspected stock.

In the given example, the information deck 510 includes fields 511, 512, 513, and 514 respectively representing the product, identified stock, supplier/customer, and sample size. The values corresponding to the fields 511, 512, 513, and 514 are adapted for each stock of commodities being inspected and appear as default values in the inspection template. Further, the value for the sample size 514 may be determined based on the identified commodity, identified supplier/customer, or governing laws, regulations, and standards. For example, the safety standard for a particular state or country may require a specified number of samples to be inspected for a particular commodity. In the given example, the inspection template is automatically generated in response to identifying the product to be inspected as “MCF 0001-AHT Combi 75” supplied by a certain Supplier “AMS” having a standard certification “QC2000.” The stock identified at a procurement site and recorded in the procurement module is “lot 1234567.” The sample size for inspection is 15 nos.

The Summary Table 520 provides a brief summary of the faults associated with the inspected samples of a product. The Summary Table 520 includes a first header column 524 representing the samples being inspected and a first header row 522 representing the various defect locations of the product being inspected. The first column 524 and first row 522 of the Summary Table 520 are provided by default in the inspection template generated by the processor. The values given under a certain column and row indicate the number of faults detected in the part represented by the corresponding column for the product represented by the corresponding row. In the given example, the value “2” under column “Chassis” and row “RF203” indicates that there are two defects found in the chassis of a product having product no. RF203. The value “0 under column “Evaporator” and row “RF204” indicates that there are no defects found in the evaporator of a product having product no. RF204. In an embodiment, the inspection template is configured to auto-populate the values under each column and row in the Summary Table 520 consequent to receiving a value under an associated field in Tables 1-n (525). For example, the value “1” under column “Chassis” and row “RF205” in Summary Table 520 may be auto-populated consequent to receiving an “x” mark under column “Discoloration” and row “RF205” in Table 1-Chassis (525). Similarly, other values in Summary Table 520 may be auto-populated corresponding to an entry in the associated columns and rows in the Tables 1-n (525).

Tables 1-n (525) represent inspection templates for parts 1-n that are inspected. In the given example, Table 1 (525) represents an inspection template for defect location: Chassis; Table 2 for defect location: Hinge; Table 3 for defect location: Beading and so on. From the example, the inspection template for part Chassis includes a first column 527 representing the product samples that are inspected and a first row 526 representing the various types of defects that may be found on the Chassis. The Table 1 (525) also includes a column “proof” (528) for uploading image file, audio file, video file, or any other document that may provide additional inspection information along with the inspection data. In the given example, an “x” marking under column “Dent” and row “RF203” indicates the presence of a defect in the nature of a dent. Similarly an “x” marking under column “Discoloration” and row “RF205” indicates the presence of a defect in the nature of discoloration. The Table 1 (525) also provides an optional field (529) for entering any deformity not specified by default in the Table 1 (525). A similar form of data entry may be followed for the rest of the Tables 2-n (525) for a corresponding part.

The inspection results for all the parts of all the samples are consolidated and provided in the Summary Table (520). Based on analyzing the inspection data in the Summary Table (520), the total no. of non-conforming samples is determined and an evaluation proposal 517 is provided on the dashboard 500. The evaluation proposal 517 may also include a recommendation to re-inspect the commodities for a same sample set or for a different sample set. The re-inspect recommendation may be provided by the processor based on determining one or more errors in the received inspection data. For example, the one or more errors may include redundant data, typographical errors, missing information, and data type errors.

In an example scenario, at a procurement site a new stock of commodities is received. In this example, the commodities refer to a stock of refrigerators. Procurement personnel at the procurement site record the receipt of the stock of refrigerators in a computer at the procurement site. The procurement personnel may record the details of the supplier supplying the received stock, the model no. of the refrigerators, the no. of refrigerators per stock, etc. The computer at the procurement site is a part of a procurement module of an integrated ERP system. A backend system in the ERP system determines that the receipt of the stock of refrigerators is configured as an inspection trigger event and sets-off an inspection trigger. In response to the inspection trigger, a processor in the backend system automatically generates an inspection template. The attributes in the inspection template are customized according to the information recorded by the procurement personnel as well as other relevant information received from other modules of the ERP system, such as sourcing module, production module, inspection/QM module, etc. Also, the data source systems in communication with the backend system provide external feeds and reports based on which, the inspection template is customized. In this example, the inspection template is customized to include information regarding the supplier, product, and stock as recorded by the procurement personnel. The sample size is also provided by default in the inspection template and is determined based on the current international safety standards provided by the data source systems. The Tables in the inspection template for collecting inspection data are provided with default header fields representing the rows and columns. The header fields are determined based on a pre-defined set of inspection parameters stored in a memory of the backend system. The pre-defined set of inspection parameters include, the parts to be inspected, the sampling procedures and inspection instructions etc., provided by one or more business modules in the ERP system such as the production module and sourcing module. Based on the pre-defined set of inspection parameters, the inspection template includes tables for collection inspection data pertaining to each of the parts to be inspected as well as the various types of defects to be examined for each of the parts. The parts to be inspected include chassis, beading, hinge, drain tray, freezer, and gasket. The type of faults to be inspected span across dents, scratches, cracks, air gap, discoloration, etc.

The generated inspection template is automatically rendered on a user interface of a portable computing device such as a PDA or a mobile device held by inspection personnel at the procurement site. The inspection personnel then inspect the stock of refrigerators by physically examining a sample set of 15 refrigerators. Based on examining the samples set, the inspection personnel enter the inspection data into the relevant fields already provided in the inspection template. The inspection data is entered using a keypad of the mobile device or a touch screen display of the mobile device. The inspection personnel may also take a photograph of the defective part using a built-in camera of the mobile device and upload the image file into the inspection template as a proof.

The inspection template also includes a Summary Table in the form of a dashboard representation providing an overall summary of the inspection data. The values in the Summary table may be automatically computed based on the values entered in the corresponding fields in the inspection tables for each inspected part. Based on the processor analyzing the Summary Table, the no. of defective samples is determined to be 3 samples for a sample size of 15. In case the acceptance no. for the refrigerator is 1 per 15 samples, the processor provides an evaluation proposal on the dashboard to reject the refrigerator stock as the no. of non-conforming samples is >1. The inspection personnel at the procurement site reject the stock and may send the refrigerator stock back to the supplier immediately after inspection, without delay. Also, based on the evaluation proposal, the sourcing module may create/update/maintain a supplier track record for future sourcing decisions.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

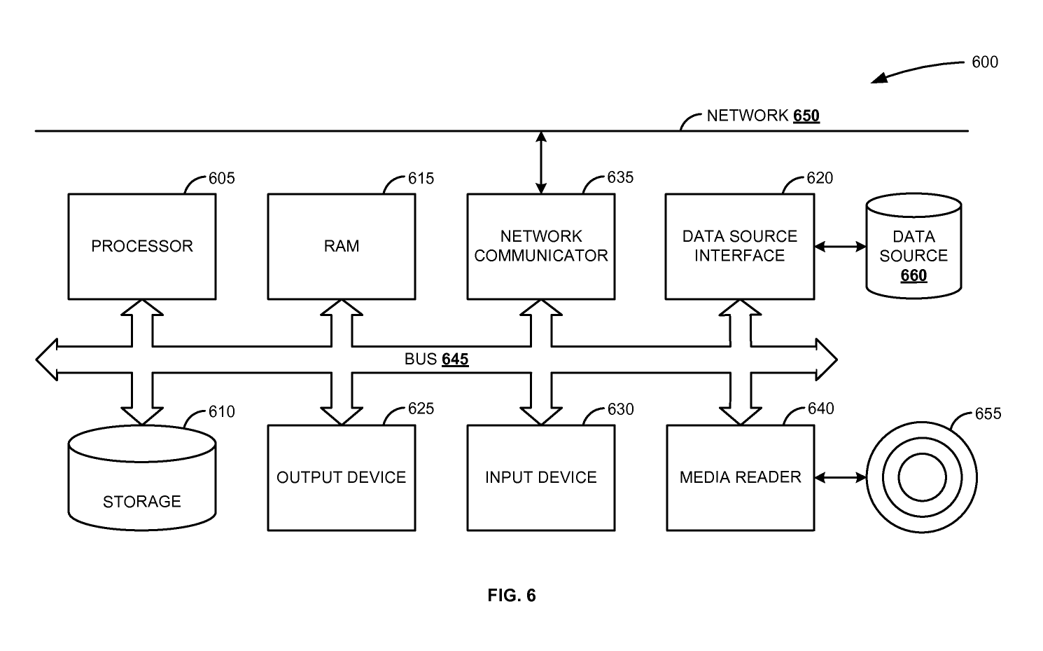

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method, in an integrated system, the method comprising:
configuring one or more events recorded in the integrated system as an inspection trigger;
setting-off the inspection trigger in response to recording at least one event of the one or more events; and
a processor of the computer:
generating an inspection template in response to the setting-off of the inspection trigger;
rendering the inspection template on an inspection device within the integrated system;
extracting inspection data from the inspection template, wherein the inspection data is collected by inspecting one or more commodities; and
providing an evaluation proposal based on analyzing the inspection data.

2. The method of claim 1, wherein the one or more events include one selected from a group consisting of receiving goods from a particular supplier, deliveries from subsidiaries, in-process control, final inspection, customer shipments, planned time of inspection, fault in production line, periodic defect analysis, periodic vendor evaluation, and strategic decision.

3. The method of claim 1, wherein generating the inspection template in response to the inspection trigger comprises automatically generating a customized inspection template in response to the inspection trigger, based on a predefined inspection plan.

4. The method of claim 3, wherein automatically generating the customized inspection template comprises dynamically adapting attributes of the inspection template according to the one or more commodities.

5. The method of claim 1, wherein rendering the inspection template on the inspection device comprises displaying the inspection template on a user interface of the inspection device.

6. The method of claim 1, wherein providing the evaluation proposal based on analyzing the inspection data comprises proposing to accept or reject the one or more commodities based on a predefined inspection plan.

7. The method of claim 1, wherein providing the evaluation proposal based on analyzing the inspection data comprises proposing a re-inspection of the commodities based on determining errors in the inspection data.

8. The method of claim 1 further comprising rendering the inspection template on a user interface of the computer.

9. An inspection device in an integrated system, the device comprising:
a memory to store a program code; and
a processor to execute the program code to:
invoke an inspection template on a user interface of the inspection device, wherein the inspection template is generated in response to recording a trigger event in the integrated system;
record inspection data for one or more commodities using the inspection template; and
render an evaluation proposal on the user interface, wherein the evaluation proposal is based on analyzing the inspection data.

10. An article of manufacture, comprising:
a computer readable storage medium having instructions which when executed by a computer causes the computer to:
generate an inspection template in response to recording a trigger event within an integrated system, based on a predefined inspection plan;
render the inspection template on a user interface of the computer in the integrated system;
extract inspection data from the inspection template, wherein the inspection data is collected by inspecting one or more commodities; and
provide an evaluation proposal based on analyzing the inspection data.

11. The article of manufacture in claim 10, wherein the inspection template comprises customized attributes including at least one of: parts to be inspected, number of parts to be inspected, order of performing inspection, and number of samples to be inspected.

12. The article of manufacture in claim 10, wherein the predefined inspection plan comprises information relating to predefined sampling procedures and inspection instructions.

13. The article of manufacture in claim 10, wherein the inspection template comprises attributes customized to a particular commodity.

14. The article of manufacture in claim 10, wherein the inspection template comprises attributes customized to a particular business partner.

15. The article of manufacture in claim 10, wherein the inspection template comprises attributes customized according to international sampling standards.

16. The article of manufacture in claim 10, wherein the inspection template comprises attributes customized according to national laws and standards pertaining to a particular territory.

17. The article of manufacture in claim 10, wherein the inspection data collected by inspecting the one or more commodities includes text, images, numerals, digital photographs, characters, and symbols.

18. An integrated system operating in a communication network, the system comprising:
an inspection device; and
a computer communicatively coupled to the inspection device, comprising a memory to store a program code, and a processor to execute the program code to:
generate an inspection template in response to recording a trigger event;
render the inspection template on the inspection device;
extract inspection data from the inspection template, wherein the inspection data is collected by inspecting one or more commodities; and
provide an evaluation proposal based on analyzing the inspection data.

19. The system of claim 18, wherein the inspection device is a portable communication device having an integrated camera.

20. The system of claim 18, wherein the integrated system is an on-demand solution accessed over the internet using a web browser.

21. The system of claim 18, wherein the integrated system is an Enterprise Resource Planning (ERP) system having one or more business modules integrated over the communication network.
